(19) United States
(12) Patent Application Publication
(10) Pub. No.: US 2004/0048496 A1
(43) Pub. Date: Mar. 11, 2004

(54) Electrical device connection port

(76) Inventor: Chi-San Chi, Luchou City (TW)

Correspondence Address: RABIN & BERDO, P.C., Suite 500, 1101 14th STREET, N.W., Washington, DC, 20005, US

(21) Appl. No.: 10/237,900

(22) Filed: Sep. 10, 2002

(51) Int. Cl. H01R 12/00

(52) U.S. Cl. 439/62

(57) ABSTRACT

A structure of an electronic device connection port is disclosed. The electrical device connection port comprises a socket at on end of a housing for connecting with an external connection port and a plurality of terminal connectors extending rearwardly from the socket and projection out of the other end of the housing opposite to the socket. The terminal connectors are inserted into apertures that are located on predetermined positions on a surface of a PCB of an electronic device and are welded therein to securely attach with a PCB and also to make an electrical contact with the circuit of the PCB. This structure of the connection port of the present invention would allow the electrical device connection port to be connected in a position perpendicular to the PCB and could be located at any position on the PCB.

### BACKGROUND OF THE INVENTION

1. Filed of the Invention

The present invention relates to an electrical connection port, and more particularly to a structure of an electrical device connection port that can be disposed on any position on a surface of the printed circuit board and thus not limiting the arrangement of the other elements of the electronic device and making the electrical device smaller and more compact.

2. Description of the Related Art

Nowadays, with the rapid development of information the functionality of computer, peripheral devices and a variety of software are correspondingly being upgraded continuously. Further, the prices are made more affordable than before to make the computer and peripheral devices become more popular in everyday work and enhance consumption of the same. The above development trend has motivated the manufacturer of visional communication products to research and develop new and advanced digital electronic devices for satisfying the wide-range and new and advanced technology computer consumers.

Taking a digital camera as an example, the small and compact size are highly appealing for the consumers. Accordingly in order to meet these market demands every major manufacturers have developed newly designed components for making smaller and thinner mini digital cameras. For satisfying the miniaturization design rule for example, for making the miniaturized digital camera, the printed circuit board (PCB) of the digital camera has to be miniaturized accordingly. In additional to the PCB, the layout of the electronic elements has to be multi-layered structure and that these multilayers has to be adhered using a surface mounted technology (SMT) and to connect the electronic elements onto the PCB in order to minimize the space occupation on the PCB. However, the use of adhesives through the use of SMT usually causes pilling off the elements due to repeated use of the external forces such as plugging in of a peripheral connection port for connecting with a computer and pulling out of the peripheral connection port.

In the light of the foregoing problems, one conventional way to overcome the above problems is to insert the terminal connectors into the apertures of the PCB to electrically connect with the PCB and then weld them into position for securing the connection port. Referring to FIG. 1, shows a conventional connection port 10 as the one used ever since the existence of computer a housing 11 comprising a socket 13 at one end for connecting to an external connection port, a plurality of terminal connectors 15 extending from the socket 13 and out of the housing 11 positioned perpendicular with respect to the socket 13. The connection port 10 is mounted onto a PCB 16 by inserting the terminal connectors 15 into apertures 161 located at a predetermined location on the PCB 16 and welding the terminal connectors 15 to secure the connection port 10 in position. In this way, the terminal connectors 15 of conventional connection port 10 is positioned perpendicular to the socket 13 and the housing 11 and the socket 13 are positioned parallel to the PCB 16. Therefore, the connection port 10 can be positioned along the four sides of the PCB 16 enabling the socket 13 of connection port 10 to project out from any of the four sides of digital camera case. However, the above-mentioned arrangement would limit the miniaturization of the digital camera, in that the space around four sides of the digital camera for having the socket 13 of connection port 10 is rendered very small, thus making it increasingly difficult to layout or arrange other electronic elements on PCB 16. Nevertheless, the front side and the back side of digital camera comprises a lot of available spaces. Accordingly, a design of a connection port 10 which allows to be mounting at any position on the surface of the PCB 16 is highly desirable.

### SUMMARY OF THE INVENTION

Accordingly, in the view of the foregoing, the present inventor makes a detailed study of related art to evaluate and consider, and uses years of accumulated experience in this field, and through several experiments, to create a new structure of a mini-electronic device of the present invention. The present invention provides an innovated cost effective electronic device connection port that can be disposed on any position on a surface of the printed circuit board and thus not limiting the arrangement of the other elements of the electrical device and making the electrical device more smaller in size and compact.

In order achieve the above objects and other objects of the present invention, a structure of an electrical device connection port is provided. The electrical device connection port comprises a socket at on end of a housing for connecting with an external connection port and a plurality of terminal connectors extending rearwardly from the socket protruding out of the other end of the housing and opposite to the socket. The terminal connectors are inserted into apertures that are located on predetermined positions on a surface of a PCB of an electronic device and are welded therein to securely attach the terminal connectors with a PCB and also to make an electrical contact with the circuit of the PCB.

According to an aspect of the present invention, the electrical device connection port is positioned perpendicular to the PCB. Thus, this would allow the electrical device connection port to be positioned anywhere on the surface of the PCB. The socket of the electrical device connection port can be projected out of front and/or backside of electronic device for connecting with an external connection port. Therefore, this arrangement would allow arrangement of other electronic elements on the PCB in a more compact manner since the electrical device connection port does not limit their arrangement. Thus, the space within the electronic device case can be fully utilized and can be more compact.

According to another aspect of the present invention, the terminal connectors of the electrical device connection port are welded into the apertures of PCB, therefore the electrical device connection port is effectively prevented from pulling off from PCB from the external pulling out and/or plugging in forces.

According another aspect of the present invention, the electronic device can be connected to a computer by connecting the electrical device connection port with another external connection port which is connected to a computer. This will allow central processor unit of the computer to retrieve the image data that are stored in the electronic device and/or transmit information from the computer to the electronic device.

According to another aspect of the present invention, the electrical device connection port comprises a female or male socket.

### BRIEF DESCRIPTION OF THE DRAWINGS

FIG. 1 is an elevational view of a conventional electrical device connection port;

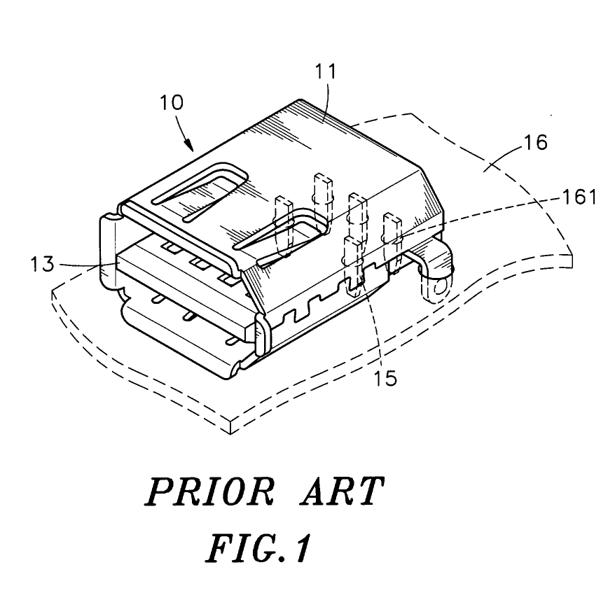

FIG. 2 is an exploded view of a electrical device connection port according to the present invention;

FIG. 3 is an elevational view of the electrical device connection port according to the present invention; and

FIG. 4 is a view of electrical device connection port of the present invention used in a digital camera.

### DESCRIPTION OF THE PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

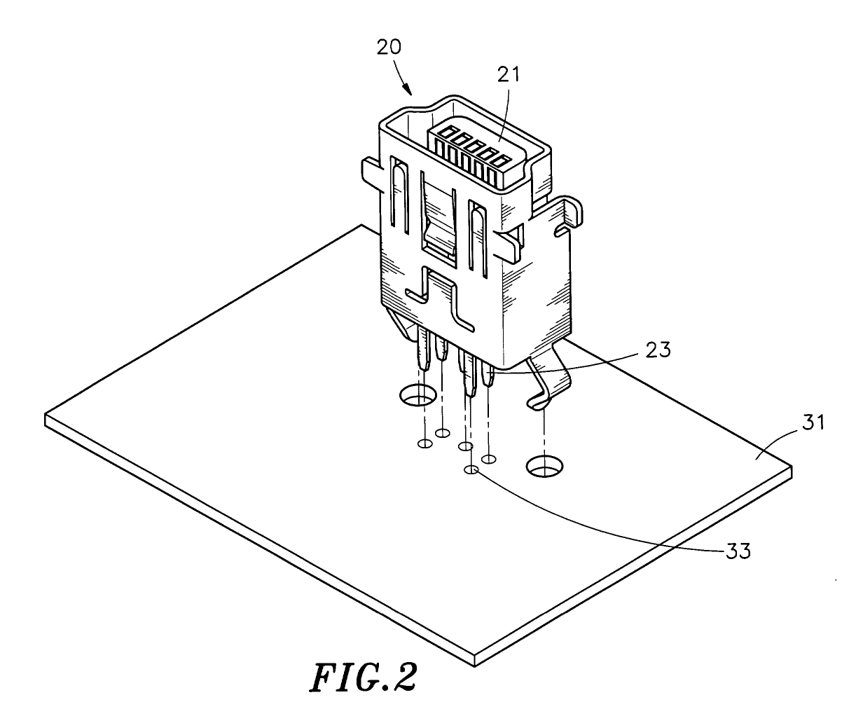

Referring to FIGS. 2, 3 and 4 show an electrical connection port 20 of the present invention. The electrical device connection port 20 comprises a socket 21 at on end of a housing for connecting with another connection port 40 and a plurality of terminal connectors 23 extending rearwardly from the socket 21 and projecting out of the other end of the housing positioned opposite to the socket 21. The terminal connectors 23 are inserted into apertures 33 that are located at a predetermined position on a surface of a PCB 31 of an electronic device 30 (for example, a digital camera) and welded therein to secure with the PCB 31 and also to make an electrical contact with the circuit of the PCB 31. This structure of the electrical device connection port 20 of the present invention would allow the electrical device connection port 20 to be connected in a position perpendicular to surface of the PCB 31.

According to an aspect of the present invention, the electrical device connection port 20 is positioned perpendicular to the surface of the PCB 31. Thus, this would allow the electrical device connection port 20 to be positioned anywhere on the PCB 31. The socket 21 of the electrical device connection port 20 can be projected out of front and/or backside of electronic device 30 for connecting with an external connection port 40. Therefore, this arrangement would allow arrangement of other electronic elements on the PCB 31 in a more compact manner since the electrical device connection port 20 does not limit their arrangement. Thus, the space with case of the electrical device (such as digital camera) more fully utilized and can be more compact.

According to another aspect of the present invention, the terminal connectors 23 of the electrical device connection port 20 are welded into the apertures 33 of PCB 31, therefore the electrical device connection 20 is effectively prevented from pulling off from PCB 31 from the pulling out and/or plugging in forces.

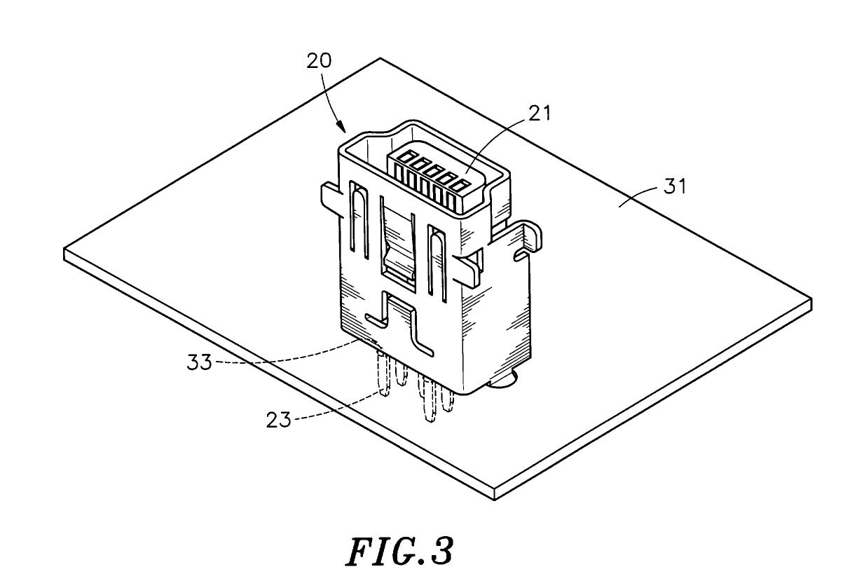

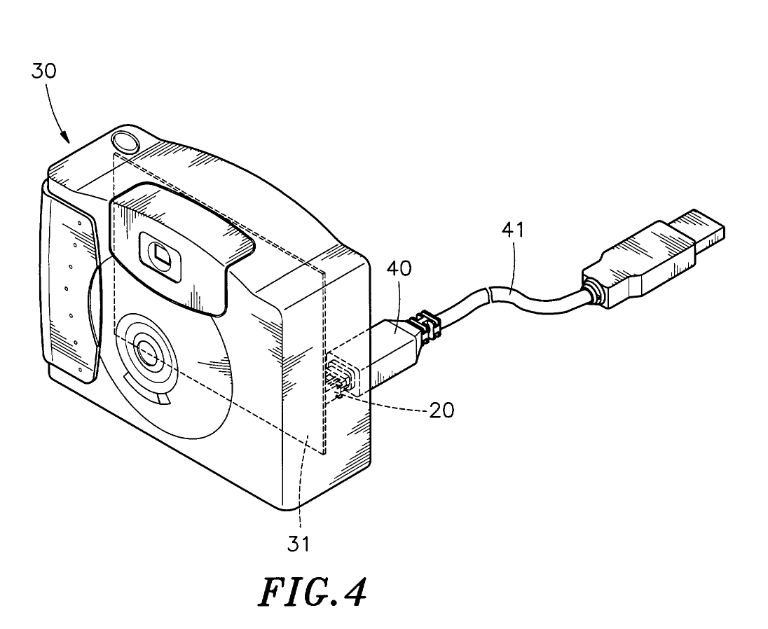

Referring to FIGS. 3 and 4, shows the electrical device connection port 20 which is similar to a widely used universal serial bus connector (USB, 1394). The electronic device 30 can be connected to a computer by connecting the electrical device connection port 20 with an external connection port 40 which is connected to a computer through a wire 41 as shown in FIG. 4. This will allow central processor unit of the computer to retrieve the image data that are stored in the electronic device 30 and/or transmit information from the computer to the electronic device 30. Further, the electrical device connection port 20 can be a female or male socket.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations which fall within the spirit and scope of the included claims. All matters set forth herein or shown in the accompanying drawings are to be interpreted in an illustrative and non-limiting sense.

What the claimed is:

1. A structure of an electrical device connection port for an electrical device, the electrical device comprising a printed circuit board, wherein the printed circuit board having a plurality of apertures for electrical connection, the structure comprising
a socket at one end of a housing to receive an external connection port; and
a plurality of terminal connectors extending rearwardly from the socket and protruding out from the other end of the housing opposite to the socket, wherein the terminal connectors are inserted into the apertures of the printed circuit board of the electronic device and welded into position on the circuit of printed circuit board so that the electrical device connection port is positioned perpendicular to a surface of the printed circuit board allowing the socket of the electrical device connection port to be projected out of front and/or back side of electrical device.

2. The structure of the electrical device connection port according to claim 1, wherein said electrical device is a digital camera.

3. The structure of the electrical device connection port according to claim 1, wherein said connection port is a universal serial bus (USB) connection port.
